(19) United States
(12) Patent Application Publication
(10) Pub. No.: US 2017/0193529 A1
(43) Pub. Date: Jul. 6, 2017

(54) METHODS AND APPARATUS TO DETERMINE A CAUSAL EFFECT OF OBSERVATION DATA WITHOUT REFERENCE DATA

(71) Applicant: The Nielsen Company (US), LLC, New York, NY (US)

(72) Inventors: Michael Sheppard, Brooklyn, NY (US); Jonathan Sullivan, Hurricane, UT (US); Peter Lipa, Tucson, AZ (US); Alejandro Terrazas, Santa Cruz, CA (US); John Charles Torres, San Diego, CA (US)

(21) Appl. No.: 15/046,052

(22) Filed: Feb. 17, 2016

Related U.S. Application Data
(60) Provisional application No. 62/273,442, filed on Dec. 31, 2015.

(51) Int. Cl. G06Q 30/02

(52) U.S. Cl. CPC G06Q 30/0201; G06Q 30/0245

(57) ABSTRACT

Methods, apparatus, systems and articles of manufacture are disclosed to determine a causal effect of observation data without reference data. An example method includes retrieving, by executing an instruction with a processor, observation data without associated reference data, eliminating a need for the processor to randomize reference data to reduce error by generating, with the processor, mutually exclusive categories of interest of the observation data, associating, by executing an instruction with the processor, each category of interest with a respective control group and treatment group; and for each iteration of a bootstrap: selecting, by executing an instruction with the processor, a random subgroup of the observation data, constraining, by executing an instruction with the processor, respective proportions of the control group and the treatment group to converge to a substantially equal value, solving for weight values of the mutually exclusive categories of interest based on the constrained proportions of the control group and the treatment group by executing an instruction with the processor, and generating, with the processor, a causal effect estimate value based on the weight values.

### RELATED APPLICATION

This patent claims the benefit of, and priority to, U.S. Provisional Application Ser. No. 62/273,442, entitled “Methods and Apparatus to Determine a Causal Effect of Observation Data Without Reference Data” and filed on Dec. 31, 2015, which is hereby incorporated herein by reference in its entirety.

### FIELD OF THE DISCLOSURE

This disclosure relates generally to market research, and, more particularly, to methods and apparatus to determine a causal effect of observation data without reference data.

### BACKGROUND

In recent years, market research efforts have collected market behavior information to determine an effect of marketing campaign efforts. During some marketing campaign efforts, adjustments are made to one or more market drivers, such as a promotional price of an item, an advertisement channel (e.g., advertisements via radio, advertisements via television, etc.), and/or in-store displays. Market analysts attempt to identify a degree to which such adjustments to market drivers affect a marketing campaign objective, such as increased unit sales.

### BRIEF DESCRIPTION OF THE DRAWINGS

FIG. 1 illustrates an example causation analysis system to determine a causal effect of observation data without reference data.

FIG. 2 is an example histogram generated by the example causation analysis system to illustrate a causal effect of a stimulus associated with the observation data.

FIGS. 3-5 are flowcharts representative of example machine readable instructions that may be executed to implement the example causation analysis system of FIG. 1.

FIG. 6 is a schematic illustration of an example processor platform that may execute the instructions of FIGS. 3-5 to implement the example causation analysis system of FIG. 1.

### DETAILED DESCRIPTION

Market researchers seek to understand whether adjusting variables within their control have a desired effect. In some examples, variables that can be controlled by those interested in the desired effect (e.g., manufacturers, merchants, retailers, etc., generally referred to herein as “market researchers”) include a price of an item, a promotional price, a promotional duration, a promotional vehicle (e.g., an adjustment related to distributed media such as television, radio, Internet, etc.), a package design, a feature, a quantity of ingredients, etc. In short, if the market researcher knows that changing a variable (e.g., a cause) leads to achievement of the marketing campaign objective (e.g., an effect), then similar marketing campaigns can proceed with a similar expectation of success.

Industry standard statistical methodologies distinguish between gathering data to identify a relationship between a variable (e.g., a market driver under the control of the market researcher) and a result (e.g., an effect observed when the variable is present) versus whether such variables are the cause of the observed result. Stated differently, market researchers know that correlation does not necessarily mean causation. Positive correlations can be consistent with positive causal effects, no causal effects, or negative causal effects. For example, taking cough medication is positively correlated with coughing, but hopefully has a negative causal effect on coughing.

Causation, unlike correlation, is a counterfactual claim in a statement about what did not happen. The statement that “X caused Y” means that Y is present, but Y would not have been present if X were not present. Caution must be exercised by market researchers regarding potential competing causes that may be present when trying to determine a cause of observed outcomes to avoid absurd conclusions. An example statement highlighting such an absurd conclusion in view of causation is that driving without seat belts prevents deaths from smoking because it kills some people who would otherwise go on to die of smoking-related disease. Competing causes may be further illustrated in a statement from the National Rifle Association that “guns don't kill people, people kill people.” In particular, one competing cause is that if you take away guns and you observe no deaths from gunshot wounds, then guns are a cause. However, another competing cause is that if you take away people and you have no deaths from gunshot wounds, then people (e.g., shooters) are a cause. As such, both illustrate simultaneous causes of the same outcome. To frame an analysis in a manner that avoids extreme and/or otherwise absurd conclusions, the question of whether “X causes Y” is better framed as “how much does X affect Y.”

Efforts to understand causation have particular challenges with individual observations. As causal effects are statements about a difference between what happened and what could have happened, then causal effects on individual behaviors cannot be measured. For example, if a causal effect of a particular drug is to be determined, then a corresponding effect can only be observed for the individual that either took that drug, or did not take that drug, but not both. Equation 1 illustrates an example formula to determine a causal effect.

τᵢ=Yᵢ(1)−Yᵢ(0) Equation 1.

In the illustrated example of Equation 1, Yᵢ(1) represents an outcome for unit i that would be observed in condition 1 (e.g., a condition in which treatment occurs), and Yᵢ(0) represents an outcome for unit i that would be observed in condition 0 (e.g., a condition in which treatment does not occur, such as in a control group). Note that in the illustrated example of Equation 1, only one condition can be observed, and the other is counterfactual.

Thus, to study an effect of the drug, an estimation of the average causal effect may be conducted in a manner consistent with example Equation 2.

E[τ]=E[Yᵢ(1)−Yᵢ(0)]=E[Yᵢ(1)]−E[Yᵢ(0)] Equation 2.

In the illustrated example of Equation 2, E[τ] (the first term) represents an expected value of the causal effect (τ), which references a population of interest rather than an individual. As described above, the second term of Equation 2 cannot be estimated, but the third term of Equation 2 is mathematically identical to the second term and, thus, can be estimated in view of the population of interest. The population of interest includes randomization that ensures equal proportions of those who took the drug and those who did not take the drug are in both groups of observations. Stated differently, the randomization averages out anything that could have been an influence other than the drug, thereby leaving only the drug effect (e.g., the causal effect).

Market researchers apply the mathematical convenience of example Equation 2 in a Naïve causal effect technique in a manner consistent with example Equation 3.

E[δ]=E[Yᵢ|dᵢ=1]−E[Yᵢ|dᵢ=0] Equation 3.

In the illustrated example of Equation 3, E[δ] (the first term) represents the Naïve estimator, the second term represents a sample mean of outcome for those observed in the treatment group (e.g., those that took the drug), and the third term represents a sample mean of outcome for those observed in the control group. However, the Naïve estimator also includes a baseline bias and a differential treatment bias. The baseline bias is a difference in the average outcome in the absence of the treatment between those in the treatment group and those in the control group. Additionally, the differential treatment effect bias is an expected difference in the treatment effect between those in the treatment and those in the control group, which is multiplied by the proportion of the population under the fixed treatment selection regime that does not select into the treatment. To derive a true causal effect that removes such bias, traditional approaches employ a randomized experiment with a control group, which substantially increases cost of the study. In particular, the randomization with the control group typically accounts for several population variables including, but not limited to, covariants, gender, age, economic disposition, etc. The randomized control group requires monitoring and analysis, which further adds to the cost of establishing and maintaining the analysis to determine the Naïve causal effect.

At least one of the de-facto standard approaches for analyzing observational data is to employ propensity score matching, which requires computationally intensive parametric regression analysis of many covariates. However, propensity score matching does not include all participants in an analysis, as some people in, for example, a medical treatment may not be matched to control people, and vice versa. Only those people that have matches to the control are maintained for the study and, as such, portions of the available data are discarded. Such parametric approaches also attempt to fit data into a predetermined distribution, resulting in some of the data being discarded. Additionally, available market behavior data may not have a corresponding set of reference data due to, for example, cost constraints and/or ethical considerations. In still other examples, available market behavior data may not have a corresponding set of reference data due to a lack of foresight at the time the observation data was acquired. In other words, at the time the observational data was collected, the market researcher may not have had any plan to further determine causation data.

Example methods, systems, apparatus and articles of manufacture disclosed herein determine a causal effect of observation data without corresponding reference data that is typically required to remove bias during a causation study. Computational costs/burdens are also reduced by examples disclosed herein by eliminating any need to acquire, sort, clean, randomize and/or otherwise manage separate reference data. Examples disclosed herein also reduce processing burdens when determining causal effects of observation data by avoiding and/or otherwise prohibiting computationally intensive parametric numerical approaches and/or regressions. Further, because examples disclosed herein avoid parametric numerical approaches, causation determination results in a relatively lower error based on, in part, avoidance of predetermined distributions in which to fit the observation data.

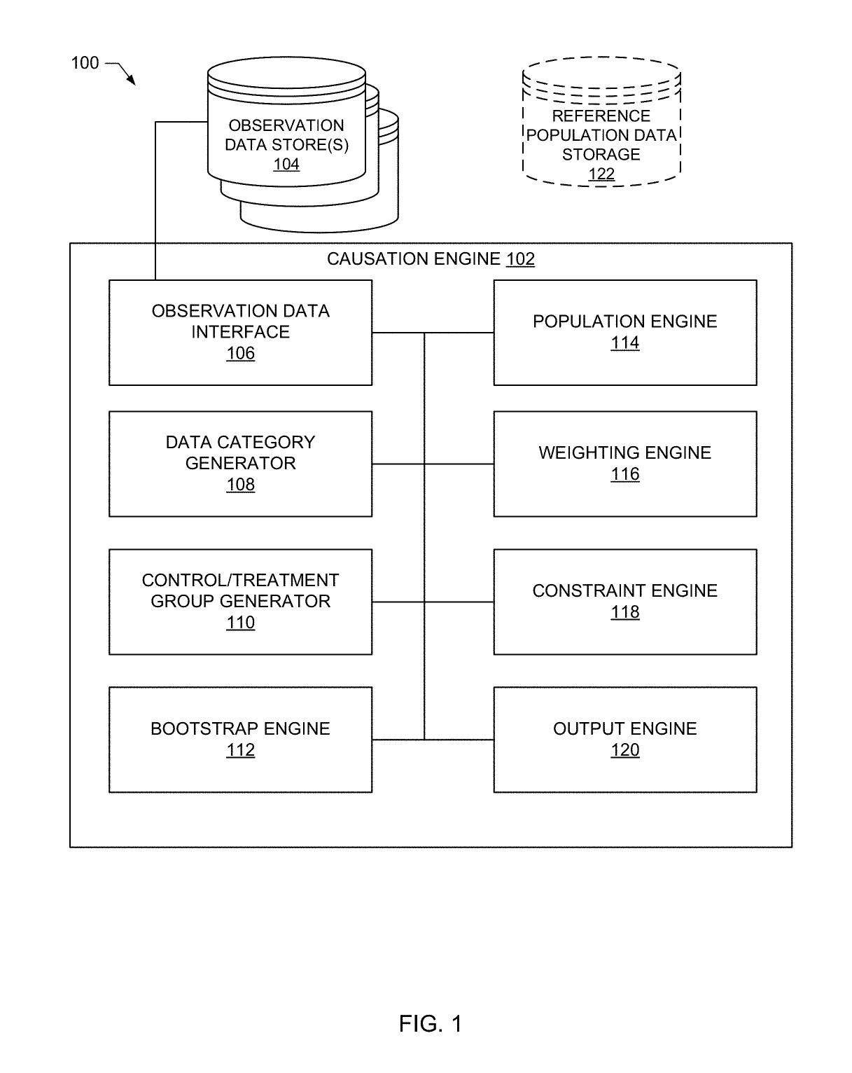

Turning to FIG. 1, an example causation analysis system 100 includes an example causation engine 102 communicatively connected to one or more observation data stores 104. The example causation engine 102 includes an example observation data interface 106 communicatively connected to the example one or more observation data stores 104, an example data category generator 108, an example control/treatment group generator 110, an example bootstrap engine 112, an example proportion engine 114, an example weighting engine 116, an example constraint engine 118, and an example output engine 120. While industry standard approaches to determining causation also require an example reference population data storage 122, examples disclosed herein facilitate causation determining in a manner that does not require the expense and/or processing burden of the example reference population data storage 122.

In operation, the example observation data interface 106 retrieves and/or otherwise receives observation data from the example observation data store 104. To illustrate example methods, apparatus, systems and/or articles of manufacture disclosed herein, observation data related to a drug trial is described. However, examples disclosed herein are not limited thereto. Other example observation data for which causation determination is desired may include, but is not limited to, advertisement exposures, tweets, product purchase instances, etc. The observation data to be described in connection with example operation of the causation analysis system 100 includes data for males and females that (a) took the drug of interest and (b) did not take the drug of interest. Additionally, the observation data may include an effect value that relates to an amount of change or perceived change when either taking the drug of interest or, in examples where a placebo is provided, an amount of change or perceived change when not taking the drug of interest.

The example data category generator 108 generates mutually exclusive data categories of interest for the causal effect study. Continuing with the example observation data related to the drug of interest, the data category generator 108 generates a category for men and a category for women. The example control/treatment group generator 110 generates a control group and a treatment group for each mutually exclusive data category of interest generated by the example data category generator 108. Table 1 illustrates the example mutually exclusive data categories and their associated control and treatment groups generated by the example data category generator 108 and example control/treatment group generator 110, respectively.

Table 1

| Control | Treatment |
|---|---|
| Males | Males |
| Females | Females |

The example bootstrap engine 112 is set to perform a threshold number of bootstrap iterations. Generally speaking, the bootstrap engine 112 facilitates a number of bootstrap sampling iterations of random subsets of the observation data to generate a histogram of the causal effect for each of (a) the males that did not take the drug (e.g., the control group that may have received a placebo or otherwise did not take the drug), (b) the females that did not take the drug, (c) the males that took the drug and (d) the females that took the drug. As described in further detail below, each of the bootstrap iterations reveals a distribution of the causal effect upon each group of interest. The example proportion engine 114 calculates proportions of each group of interest from the random subgroup of the observation data, which is selected by the example observation data interface 106. In particular, the example proportion engine 114 selects one of the data categories of interest (e.g., males) and calculates a proportion value of the control group and the treatment group that is representative of the random subgroup selected by the example observation data interface 106 during that particular iteration of the bootstrap. In the event there are one or more additional categories of interest (e.g., females), then the example proportion engine 114 selects the additional category of interest and calculates a corresponding proportion value of the control group and the treatment group that is representative of the random subgroup selected by the example observation data interface 106. Because the subgroup of the observation data was selected randomly, the proportion of the males in the control group may not be equal to the proportion of males in the treatment group. Similarly, the proportion of the females in the control group may not be equal to the proportion of females in the treatment group. However, examples disclosed herein mathematically set these two proportion values (e.g., the proportion of males in control with the proportion of males in treatment) substantially equal to each other (e.g., within 1% of an equal value) by evaluating weights for each category of interest to identify participant weights that allow a new common weight value to be mathematically true, as described in further detail below. Generally speaking, examples disclosed herein employ randomized experiments of the observation data in a manner that (a) avoids the need for the reference data 122 (and/or computational burdens associated therewith), (b) avoids computationally intensive regressions, (c) avoids errors and/or computational burdens associated with force-fitting data into a pre-defined distribution, and (d) aligns the proportions for each category of interest to be equal to each other.

The example weighting engine 116 establishes weights based on the proportions calculated by the example proportion engine 114. In particular, the example weighting engine 116 determines weight values for (a) the males in the control group, (b) the females in the control group, (c) the males in the treatment group, and (d) the females in the treatment group, as shown in example Table 2.

Table 2

| Control | Treatment |
|---|---|
| Males (M_{C}) W_{CM} | Males (M_{T}) W_{TM} |
| Females (F_{C}) W_{CF} | Females (F_{T}) W_{TF} |

In the illustrated example of Table 2, M_{C} represents a number of samples from the randomly selected subset in which a male participant did not take the drug of interest, F_{C} represents a number of samples from the randomly selected subset in which a female participant did not take the drug of interest, M_{T} represents a number of samples from the randomly selected subset in which a male participant took the drug of interest, and F_{T} represents a number of samples from the randomly selected subset in which a female participant took the drug of interest. Additionally, in the illustrated example of Table 2, W_{CM} represents a weight value associated with M_{C}, W_{TM} represents a weight value associated with M_{T}, W_{CF} represents a weight value associated with F_{C}, and W_{TF} represents a weight value associated with F_{T}.

As described above, randomized experiments seek to establish proportional uniformity between participants exposed to a stimulus (e.g., participants that took a drug, participants that saw an advertisement, etc.) and participants not exposed to the stimulus. Despite actual differences in the raw random subset between the control and treatment groups for the male and female categories, the example weighting engine establishes and/or otherwise estimates weight values so that the proportion/fraction of males in the control is the same fraction as those found in the males in the treatment, as shown by example Equations 4 and 5.

$$\begin{matrix}\frac{( {M}_{C} ) {W}_{T}}{( ( {M}_{C} ) {W}_{CM} + ( {F}_{C} ) {W}_{CF} )} = {p}_{CM} . \\ where \text{:} 1 - {p}_{CM} = {p}_{CF} & Equation 4 \\ \frac{( {M}_{T} ) {W}_{TM}}{( ( {M}_{T} ) {W}_{TM} + ( {F}_{T} ) {W}_{TF} )} = {p}_{TM} . \\ where \text{:} 1 - {p}_{TM} = {p}_{TF} & Equation 5\end{matrix}$$

In the illustrated example of Equation 4, p_{C,M} represents a proportion of the males in the control group found in the randomly selected subset of the observation data, and p_{CF} represents a proportion of the females in the control group found in the randomly selected subset of the observation data.

Similarly, in the illustrated example of Equation 5, p_{TM} represents a proportion of the males in the treatment group found in the randomly selected subset of the observation data, and p_{TF} represents a proportion of the females in the treatment group found in the randomly selected subset of the observation data. To establish equal proportions for the proportion of males in the control (p_{CM}) and the proportion of males in the treatment (p_{RM}), thereby reducing bias during the bootstrap iteration, the example weighting engine 116 solves example Equations 4 and 5 for values of W_{CM}, W_{CF}, W_{TM} and W_{TF} to allow p_{TM} and p_{CM} to converge to a common value.

While example Equation 4 illustrates the proportion of the males in the control and example Equation 5 illustrates the proportion of the males in the treatment, example Equations 6 and 7 illustrate the proportion of the females in the control and the proportion of the females in the treatment, respectively.

$$\begin{matrix}\frac{( {F}_{C} ) {W}_{CF}}{( ( {F}_{C} ) {W}_{CF} + ( {M}_{C} ) {W}_{CM} )} = {p}_{CF} . \\ where \text{:} 1 - {p}_{CF} = {p}_{CM} & Equation 6 \\ \frac{( {F}_{T} ) {W}_{TF}}{( ( {F}_{T} ) {W}_{TF} + ( {M}_{T} ) {W}_{TM} )} = {p}_{TF} . \\ where \text{:} 1 - {p}_{TF} = {p}_{TF} & Equation 7\end{matrix}$$

In the illustrated example of Equations 6 and 7, the example weighting engine 116 solves for values of W_{CF}, W_{CM}, W_{TF} and W_{TM} to allow p_{CF} and p_{TF} to converge to a common value, thereby reducing bias during the bootstrap iteration.

The example weighting engine 116 calculates the weighted Naïve effect estimate value as the difference between the control group and the treatment group for each of the categories of interest (e.g., the males and the females) during the bootstrap iteration. Such weighted Naïve effect estimate values are plotted by the example output engine, and the example bootstrap engine determines whether the threshold number of bootstrap iterations are complete. If not, then the bootstrap engine 112 increments a bootstrap counter and a new random subgroup of the observation data is acquired from the example observation data store 104. During the one or more successive iterations of the bootstrap, new proportions of the randomly selected subgroup are calculated (e.g., p_{CM}, p_{TM}, p_{CF} and p_{TF}) and new weights are estimated to allow the proportions to converge to an equal value, as described above. Additionally, such iterations are performed only with the observation data, thereby reducing processor demands typically required to also process voluminous reference data with traditional approaches at randomization.

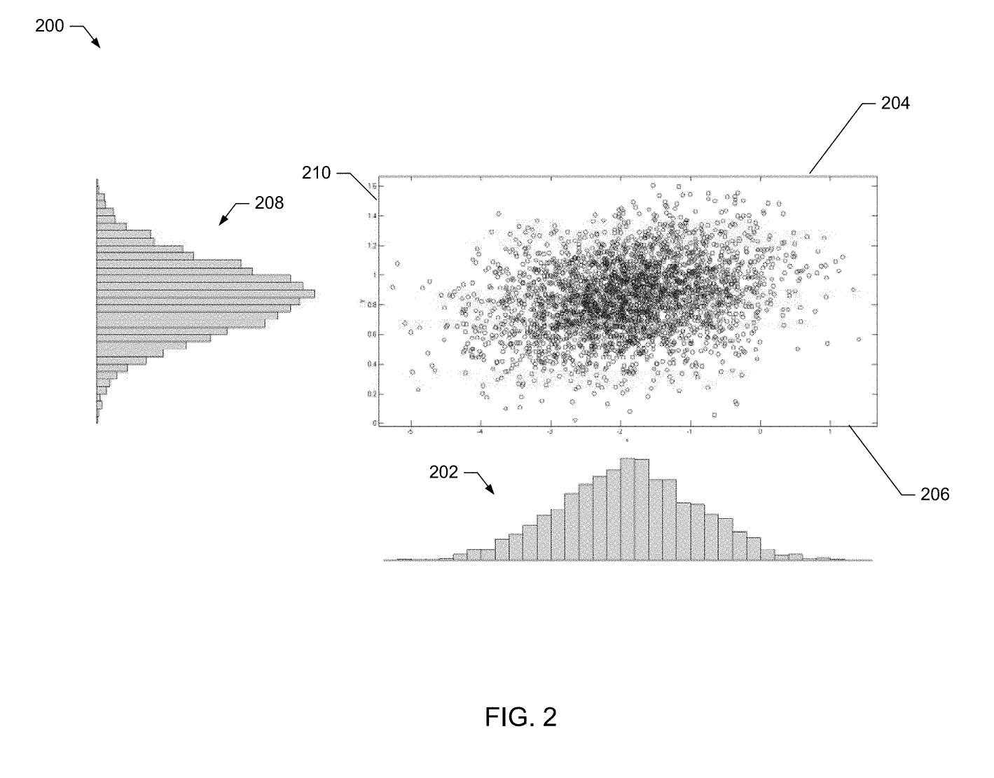

On the other hand, after the bootstrap engine 112 determines that the threshold number of bootstrap iterations is complete, the example output engine 120 generates an output of the histogram that results from each iteration of the bootstrap, as shown in FIG. 2. In the illustrated example of FIG. 2, a comparison plot 200 for males that received the drug of interest shows a traditional Naïve causal effect histogram 202 with corresponding data points in a scatter plot 204. Generally speaking, the example comparison plot 200 of FIG. 2 answers the question regarding what is the causal effect of the drug treatment for males. As described above, the traditional Naïve causal effect techniques are unweighted and, instead, rely upon reference population data that may or may not include control over one or more computationally intensive regressions of covariants (e.g., gender, age, economic disposition, etc.). The example traditional Naïve causal effect histogram 202 illustrates that the treatment for males has a negative effect, as shown by the example x-axis 206 value of approximately negative two (−2).

The illustrated example of FIG. 2 also includes a bootstrap effect histogram 208, and corresponding points on the example scatter plot 206, that does not require data from the example reference population data storage 122, does not require computationally intensive regression(s), eliminates processing requirements to randomize reference data, and does not require fitting to a pre-determined distribution. As described above, the bootstrap effect histogram 208 reflects results from randomized subsets of the observation data during each iteration, in which participant weights are calculated in view of a constraint that the proportions of each group (e.g., control and treatment) are equal. The example bootstrap effect histogram 208 illustrates that the treatment for males has a positive effect, as shown by the example y-axis 210 value of approximately zero point eight (0.8). Accordingly, the example bootstrap effect histogram 208 reflects an improved accuracy over traditional unweighted regression techniques of the Naïve causal effect, as well as distribution results that have a relatively narrower distribution. Appendix A illustrates example code to generate the comparison plot 200 of FIG. 2.

While an example manner of implementing the example causation analysis system 100 of FIG. 1 is illustrated in FIGS. 1 and 2, one or more of the elements, processes and/or devices illustrated in FIG. 1 may be combined, divided, re-arranged, omitted, eliminated and/or implemented in any other way. Further, the example causation engine 102, the example observation data interface 106, the example data category generator 108, the example control/treatment group generator 110, the example bootstrap engine 112, the example proportion engine 114, the example weighting engine 116, the example constraint engine 118, the example output engine 120, the example observation data store(s) 104 and/or, more generally, the example causation analysis system 100 of FIG. 1 may be implemented by hardware, software, firmware and/or any combination of hardware, software and/or firmware. Thus, for example, any of the example causation engine 102, the example observation data interface 106, the example data category generator 108, the example control/treatment group generator 110, the example bootstrap engine 112, the example proportion engine 114, the example weighting engine 116, the example constraint engine 118, the example output engine 120, the example observation data store(s) 104 and/or, more generally, the example causation analysis system 100 of FIG. 1 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example causation engine 102, the example observation data interface 106, the example data category generator 108, the example control/treatment group generator 110, the example bootstrap engine 112, the example proportion engine 114, the example weighting engine 116, the example constraint engine 118, the example output engine 120, the example observation data store(s) 104 and/or, more generally, the example causation analysis system 100 of FIG. 1 is/are hereby expressly defined to include a tangible computer readable storage device or storage disk such as a memory, a digital versatile disk (DVD), a compact disk (CD), a Blu-ray disk, etc. storing the software and/or firmware. Further still, the example causation analysis system 100 of FIG. 1 may include one or more elements, processes and/or devices in addition to, or instead of, those illustrated in FIG. 1, and/or may include more than one of any or all of the illustrated elements, processes and devices.

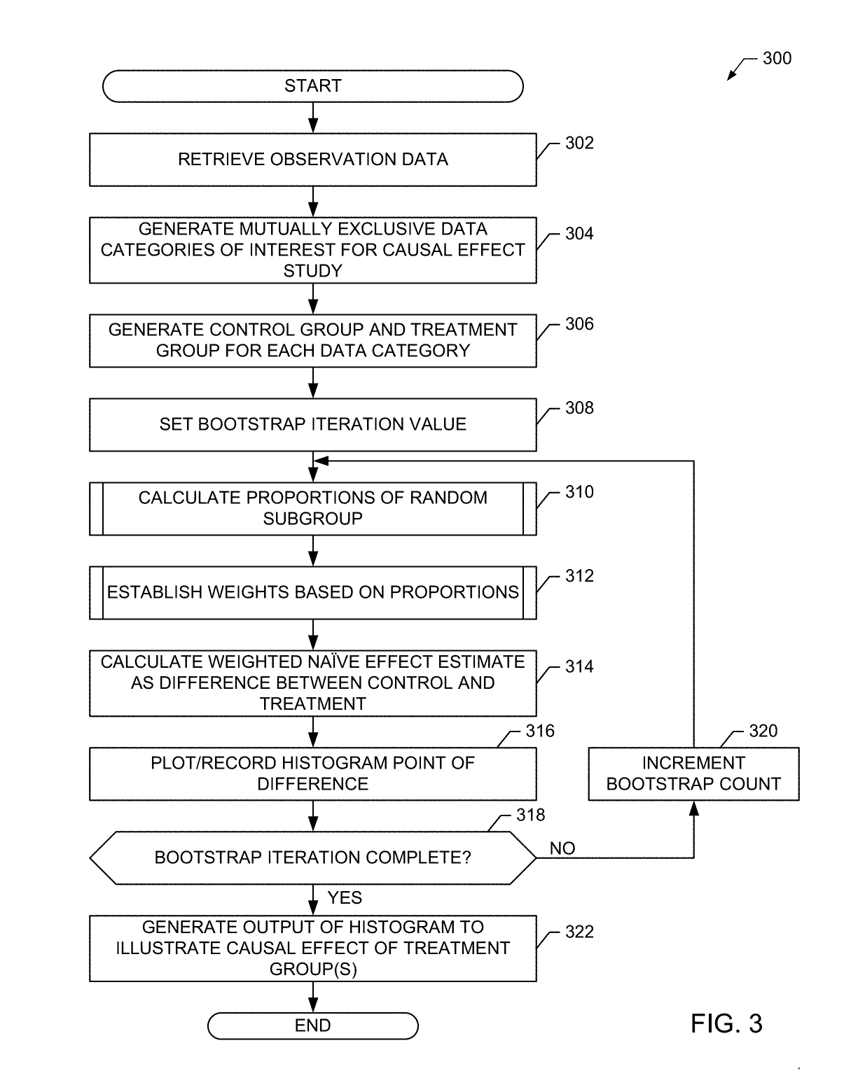

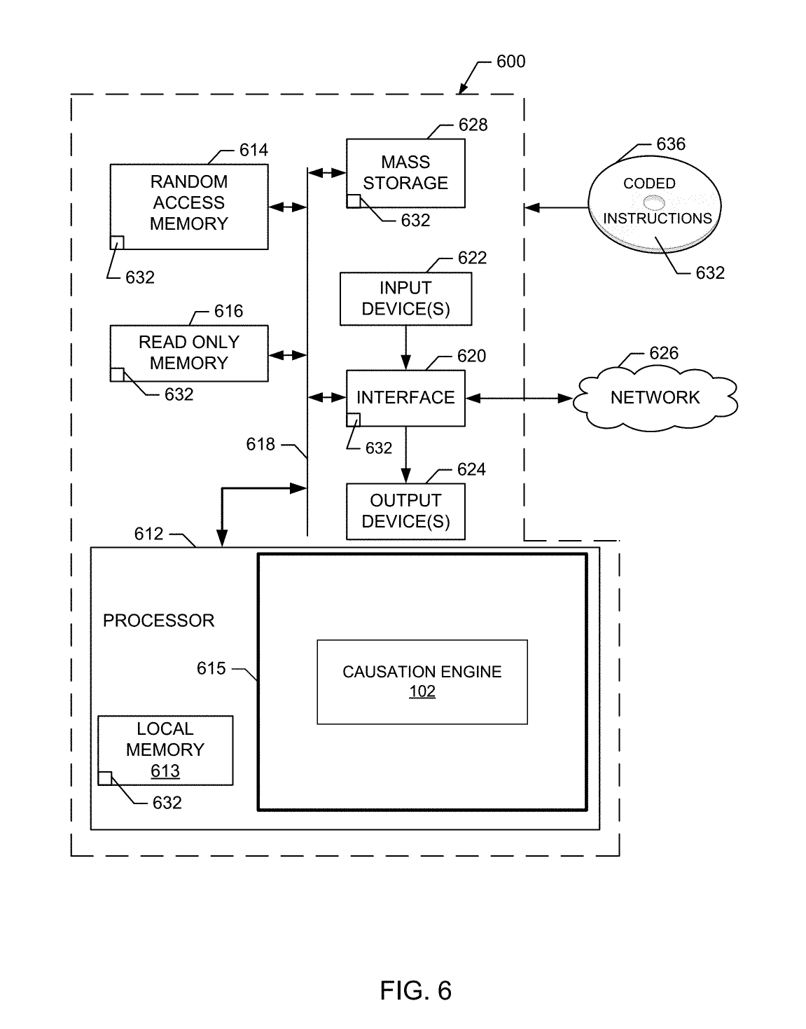

Flowcharts representative of example machine readable instructions for implementing the causation analysis system 100 of FIG. 1 are shown in FIGS. 3-5. In these examples, the machine readable instructions comprise a program for execution by a processor such as the processor 612 shown in the example processor platform 600 discussed below in connection with FIG. 6. The programs may be embodied in software stored on a tangible computer readable storage medium such as a CD-ROM, a floppy disk, a hard drive, a digital versatile disk (DVD), a Blu-ray disk, or a memory associated with the processor 612, but the entire programs and/or parts thereof could alternatively be executed by a device other than the processor 612 and/or embodied in firmware or dedicated hardware. Further, although the example programs are described with reference to the flowcharts illustrated in FIGS. 3-5, many other methods of implementing the example causation analysis system 100 may alternatively be used. For example, the order of execution of the blocks may be changed, and/or some of the blocks described may be changed, eliminated, or combined.

As mentioned above, the example processes of FIGS. 3-5 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 3-5 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

The program 300 of FIG. 3 begins at block 302 where the example observation data interface 106 retrieves and/or otherwise receives observation data from the example observation data store(s) 104. As described above, observation data may include any type of data for which a market analyst desires to learn of causation related to a stimulus (e.g., a drug treatment stimulus, an advertisement stimulus, etc.). The example data category generator 108 generates mutually exclusive categories of interest for a causal effect determination (block 304). While the examples disclosed above describe categories of males and females to determine corresponding causal effects for a drug of interest, examples disclosed herein are not limited thereto. The example control/treatment group generator 110 generates a control group and a treatment group for each corresponding category of interest (block 306).

To apply randomization in an effort to reduce (e.g., minimize) bias, the example bootstrap engine 112 sets a bootstrap iteration threshold value (block 308), and the example proportion engine 114 calculates proportions of each category and group of interest from selected random subgroups of the observation data (block 310). As described above, the selected random subgroups may have raw proportional values that are not equal to each other. As such, the example weighting engine 116 establishes weights based on the raw proportions to facilitate convergence of dissimilar proportional values between categories and groups of interest (block 312).

The example weighting engine calculates a weighted Naïve effect estimate value as the difference between the control group and the treatment group of the randomly selected subgroup of observation data (block 314), and the example output engine 120 plots and/or otherwise stores a histogram data point representing the causal effect (block 316). If the example bootstrap engine 112 determines that the bootstrap iterations are not complete (block 318), then the example bootstrap engine 112 increments the bootstrap count (block 320), and control returns to block 310 to repeat another bootstrap iteration. On the other hand, if the bootstrap count has been satisfied (block 318), then the example output engine 120 generates an output histogram to illustrate the causal effect of the stimulus of interest on one or more of the categories of interest (block 322).

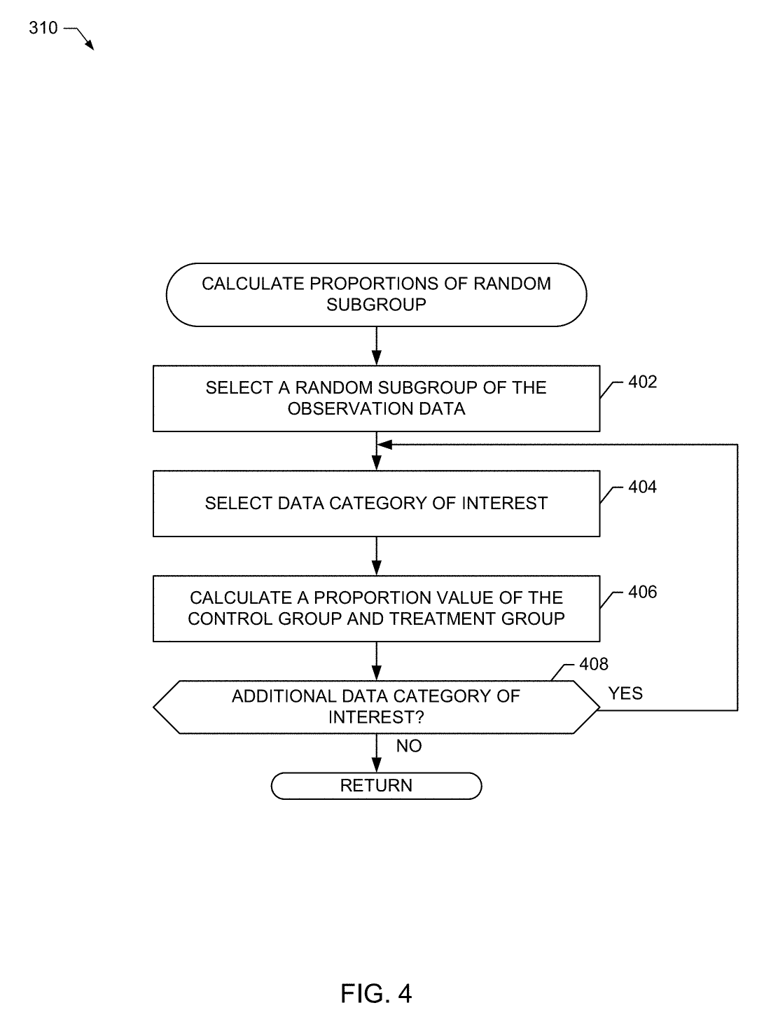

FIG. 4 includes additional detail associated with calculating the proportions of the random subgroup of bock 310. In the illustrated example of FIG. 4, the example observation data interface 106 selects a random subgroup of the observation data (block 402), and the example proportion engine 114 selects one of the data categories of interest (block 404). Consistent with the examples described above, a first category of interest may include males in the study of a causal effect of a drug of interest. The example proportion engine 114 calculates a proportion value of the control group and the treatment group from the selected random subgroup, which reflects raw proportion values (block 406). As described above, these raw values are used to derive participant weighting values for the categories of interest. The example observation data interface 106 determines whether one or more additional categories of interest reside in the study (block 408) and, if so, control returns to block 404 to select the additional category of interest for which proportion information is calculated. Otherwise, the example program of FIG. 4 ends and control returns to block 312.

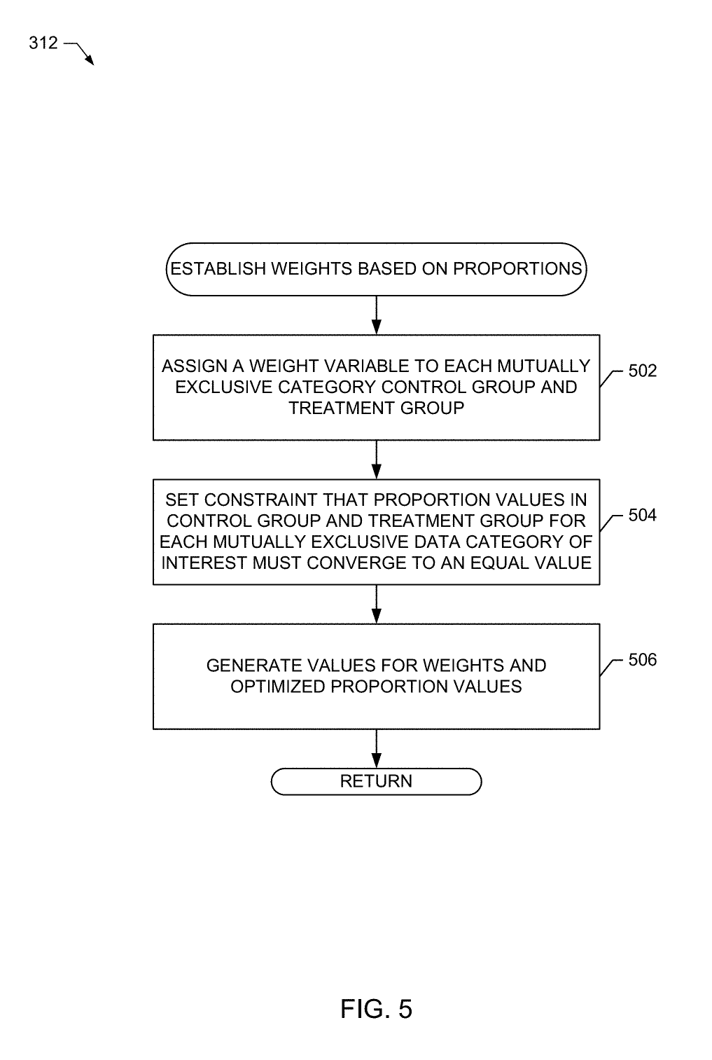

FIG. 5 includes additional detail associated with establishing weights based on the calculated raw proportion values of the categories of interest (block 312). In the illustrated example of FIG. 5, the example weighting engine 116 assigns a weight variable to each mutually exclusive category control group and treatment group (block 502), as shown by example Table 2. The example constraint engine 118 sets a constraint that the proportion values in the control group and the treatment group for a category of interest must converge to a similar value (e.g., equal) (block 504). The example weighting engine 116 generates values for the weighting variables to allow the proportions to converge to a similar value, thereby revealing an optimized proportion value estimate (block 506). As described above, the example weighting engine 116 may employ example Equations 4 through 7 to estimate optimized proportion values for (a) p_{CM}=p_{TM} and (b) p_{CF}=p_{TF}. The program 312 of FIG. 5 then returns to block 314.

FIG. 6 is a block diagram of an example processor platform 600 capable of executing the instructions of FIGS. 3-5 to implement the causation analysis system 100 of FIG. 1. The processor platform 600 can be, for example, a server, a personal computer, an Internet appliance, a gaming console, a set top box, or any other type of computing device.

The processor platform 600 of the illustrated example includes a processor 612. The processor 612 of the illustrated example is hardware. For example, the processor 612 can be implemented by one or more integrated circuits, logic circuits, microprocessors or controllers from any desired family or manufacturer. In the illustrated example of FIG. 6, the processor 612 includes one or more example processing cores 615 configured via example instructions 632, which include the example instructions of FIGS. 3-5 to implement the example causation analysis system 100 and/or causation engine 102 of FIG. 1.

The processor 612 of the illustrated example includes a local memory 613 (e.g., a cache). The processor 612 of the illustrated example is in communication with a main memory including a volatile memory 614 and a non-volatile memory 616 via a bus 618. The volatile memory 614 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 616 may be implemented by flash memory and/or any other desired type of memory device. Access to the main memory 614, 616 is controlled by a memory controller.

The processor platform 600 of the illustrated example also includes an interface circuit 620. The interface circuit 620 may be implemented by any type of interface standard, such as an Ethernet interface, a universal serial bus (USB), and/or a PCI express interface.

In the illustrated example, one or more input devices 622 are connected to the interface circuit 620. The input device(s) 622 permit(s) a user to enter data and commands into the processor 612. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 624 are also connected to the interface circuit 620 of the illustrated example. The output devices 624 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 620 of the illustrated example, thus, typically includes a graphics driver card, a graphics driver chip or a graphics driver processor.

The interface circuit 620 of the illustrated example also includes a communication device such as a transmitter, a receiver, a transceiver, a modem and/or network interface card to facilitate exchange of data with external machines (e.g., computing devices of any kind) via a network 626 (e.g., an Ethernet connection, a digital subscriber line (DSL), a telephone line, coaxial cable, a cellular telephone system, etc.).

The processor platform 600 of the illustrated example also includes one or more mass storage devices 628 for storing software and/or data. Examples of such mass storage devices 628 include floppy disk drives, hard drive disks, compact disk drives, Blu-ray disk drives, RAID systems, and digital versatile disk (DVD) drives.

The coded instructions 632 of FIGS. 3-5 may be stored in the mass storage device 628, in the volatile memory 614, in the non-volatile memory 616, and/or on a removable tangible computer readable storage medium such as a CD or DVD.

From the foregoing, it will be appreciated that methods, apparatus and articles of manufacture have been disclosed which improve processor efficiency when calculating causal effects of a stimulus for observation data by avoiding computationally intensive parametric regressions and, instead, facilitate bootstrap iterations with random subsets of only the observation data. In some examples above, no parametric regressions are performed. In some examples disclosed herein, a need to procure, validate and maintain reference data sets of controls for randomized experiments is eliminated. Rather, randomization facilitated by examples disclosed herein is accomplished with only the available observation data. In such examples, no reference data is employed to facilitate randomization techniques typically used with industry standard approaches. As such, processing efforts are reduced by examples disclosed herein that facilitate randomization using only observational data rather than voluminous reference data.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

```
APPENDIX A
function testcausal
keepgoing=true;
while keepgoing
% Create random
num=1e4;
cat=(rand(num,2)<rand( ));
% Create random measurement
indx=(cat(:,1)==0); meas(indx)=normrnd(100,10,1,sum(indx));
indx=(cat(:,1)==1); meas(indx)=normrnd(200,10,1,sum(indx));
meas=meas(:);
% Causal effect
indx=(cat(:,2)==1);
truecausal=normrnd(1,0,sum(indx),1);
meas(indx)=meas(indx)+truecausal;
mean(truecausal)
%Niave first approach
nvc=mean(meas(cat(:,2)==1))−mean(meas(cat(:,2)==0));
if nvc<0
  keepgoing=false;
end
end
x0 = [.5;.5;1;1;1;1];
Aeq = [1 1 0 0 0 0]; beq=1;
lb = [0 0 1 1 1 1]; ub=[1 1 Inf Inf Inf Inf];
clear M
  % Bootstrap
for k1=1:1e6
  indx=randi(num,num,1);
  cat2=cat(indx,:); meas2=meas(indx);
  M(k1,1)=mean(meas2(cat2(:,2)==1))−mean(meas2(cat2(:,2)==0));
  % mean(meas(cat2(:,1)==0&cat2(:,2)==1))−
mean(meas(cat2(:,1)==0&cat2(:,2)==0))
  LIA=ismember(cat2,[0 0],‘rows’); A=sum(LIA);
  LIB=ismember(cat2,[0 1],‘rows’); B=sum(LIB);
  LIC=ismember(cat2,[1 0],‘rows’); C=sum(LIC);
  LID=ismember(cat2,[1 1],‘rows’); D=sum(LID);
  % [A,B,C,D]
f = @(x)myfun2(x,A,B,C,D);
  [x,FVAL,EXITFLAG] = fmincon(f,x0,[ ],[ ],Aeq,beq,lb,ub);
  x
p0=x(1);
p1=x(2);
w1=x(3);
w2=x(4);
w3=x(5);
w4=x(6);
  % fv2=[A*w1 / (A*w1+C*w3) , B*w2/(B*w2+D*w4) , C*w3 /
(A*w1+C*w3) , D*w4/(B*w2+D*w4)];
  % [w1*A/p0 w3*C/p1 w2*B/p0 w4*D/p1]
  % [(((w1*A/p0)+(w3*C/p1))+((w2*B/p0)+(w4*D/p1)))/2 A+B+C+D]
  MM(k1,:)=[A B C D ((w1*A/p0)+(w3*C/p1)) ((w2*B/p0)+(w4*D/p1))
A+B+C+D];
  w=x(3:end); w=w./sum(w);
  CN=(sum(meas2(LIA))*w(1)+sum(meas2(LIC))*w(3));
  CD=(sum((LIA))*w(1)+sum((LIC))*w(3));
  C=CN/CD;
  TN=(sum(meas2(LIB))*w(2)+sum(meas2(LID))*w(4));
  TD=(sum((LIB))*w(2)+sum((LID))*w(4));
  T=TN/TD;
  M(k1,2)=T−C;
  if mod(k1,10)==0
    plot(M(:,1),M(:,2),‘.’)
    mean(M)
    cov(M)
    pause(1)
  end
end
  function f = myfun2(x,A,B,C,D)
  p0=x(1);
  p1=x(2);
  w1=x(3);
  w2=x(4);
  w3=x(5);
  w4=x(6);
  %f= (A*(1 − p0)*w1 − C *p0*w3)\hat{ }2 + (B*(1 − p0)*w2 −
  D*p0*w4)\hat{ }2 + (−A *p1*w1 + C*(1 − p1)*w3)\hat{ }2 + (−B*p1*w2 +
  D*(1 − p1)*w4)\hat{ }2;
  f1=(1−p0)*A*w1 + (−p0)*C*w3;
  f2=(1−p0)*B*w2 + (−p0)*D*w4;
  f3=(1−p1)*C*w3 + (−p1)*A*w1;
  f4=(1−p1)*D*w4 + (−p1)*B*w2;
  [A*w1 / (A*w1+C*w3) , B*w2/(B*w2+D*w4) , C*w3 /
  (A*w1+C*w3) , D*w4/(B*w2+D*w4)];
  x;
  f=f1\hat{ }2+f2\hat{ }2+f3\hat{ }2+f4\hat{ }2;
```

What is claimed is:

1. A computer-implemented method, comprising:
retrieving, by executing an instruction with a processor, observation data without associated reference data;
eliminating a need for the processor to randomize reference data to reduce error by generating, with the processor, mutually exclusive categories of interest of the observation data;
associating, by executing an instruction with the processor, each category of interest with a respective control group and treatment group; and
for each iteration of a bootstrap:
selecting, by executing an instruction with the processor, a random subgroup of the observation data;
constraining, by executing an instruction with the processor, respective proportions of the control group and the treatment group to converge to a substantially equal value;
solving for weight values of the mutually exclusive categories of interest based on the constrained proportions of the control group and the treatment group by executing an instruction with the processor; and
generating, with the processor, a causal effect estimate value based on the weight values.

2. The method as defined in claim 1, further including generating a histogram of respective iterations of the bootstrap to reveal a causal effect of the stimulus on at least one of the mutually exclusive categories of interest.

3. The method as defined in claim 1, wherein the generating of the causal effect estimate value includes calculating a naïve estimate difference value between the control group and the treatment group.

4. The method as defined in claim 1, further including calculating raw proportion values for the control group and the treatment group from the random subgroup of observation data.

5. The method as defined in claim 4, further including calculating an optimized proportion value for the control group and the treatment group based on the weight values and the constraint to converge to an equal value.

6. The method as defined in claim 1, wherein the observation data is indicative of participants that (a) have been exposed to a stimulus and (b) have not been exposed to the stimulus.

7. The method as defined in claim 6, wherein the control group is indicative of a first portion of the observation data not associated with the stimulus and the treatment group is indicative of a second portion of the observation data associated with the stimulus.

8. An apparatus, comprising:
an observation data interface to retrieve observation data without associated reference data;
a data category generator to eliminate a need to randomize reference data to reduce error by generating mutually exclusive categories of interest of the observation data;
a control/treatment group generator to associate each category of interest with a respective control group and treatment group;
a bootstrap engine to select a random subgroup of the observation data for each iteration of a bootstrap;
a constraint engine to constrain respective proportions of the control group and the treatment group to converge to a substantially equal value for each iteration of the bootstrap;
a weighting engine to solve for weight values of the mutually exclusive categories of interest based on the constrained proportions of the control group and the treatment group for each iteration of the bootstrap; and
an output engine to generate a causal effect estimate value based on the weight values for each iteration of the bootstrap.

9. The apparatus as defined in claim 8, wherein the output engine is to generate a histogram of respective iterations of the bootstrap to reveal a causal effect of the stimulus on at least one of the mutually exclusive categories of interest.

10. The apparatus as defined in claim 8, wherein the bootstrap engine is to calculate a naïve estimate difference value between the control group and the treatment group.

11. The apparatus as defined in claim 8, further including a population engine is to calculate raw proportion values for the control group and the treatment group from the random subgroup of observation data.

12. The apparatus as defined in claim 11, wherein the constraint engine is to calculate an optimized proportion value for the control group and the treatment group based on the weight values and the constraint to converge to an equal value.

13. The apparatus as defined in claim 8, wherein the observation data is indicative of participants that (a) have been exposed to a stimulus and (b) have not been exposed to the stimulus.

14. The apparatus as defined in claim 13, wherein the control group is indicative of a first portion of the observation data not associated with the stimulus and the treatment group is indicative of a second portion of the observation data associated with the stimulus.

15. A tangible computer readable storage medium comprising instructions that, when executed, cause a processor to, at least:
retrieve observation data without associated reference data;
eliminate a need for the processor to randomize reference data to reduce error by generating mutually exclusive categories of interest of the observation data;
associate each category of interest with a respective control group and treatment group; and
for each iteration of a bootstrap:
select a random subgroup of the observation data;
constrain respective proportions of the control group and the treatment group to converge to a substantially equal value;
solve for weight values of the mutually exclusive categories of interest based on the constrained proportions of the control group and the treatment group by executing an instruction with the processor; and
generate a causal effect estimate value based on the weight values.

16. The machine readable instructions as defined in claim 15, wherein the instructions, when executed, cause the processor to generate a histogram of respective iterations of the bootstrap to reveal a causal effect of the stimulus on at least one of the mutually exclusive categories of interest.

17. The machine readable instructions as defined in claim 15, wherein the instructions, when executed, cause the processor to calculate a naïve estimate difference value between the control group and the treatment group.

18. The machine readable instructions as defined in claim 15, wherein the instructions, when executed, cause the processor to calculate raw proportion values for the control group and the treatment group from the random subgroup of observation data.

19. The machine readable instructions as defined in claim 18, wherein the instructions, when executed, cause the processor to calculate an optimized proportion value for the control group and the treatment group based on the weight values and the constraint to converge to an equal value.

20. The machine readable instructions as defined in claim 15, wherein the instructions, when executed, cause the processor to employ observation data that is indicative of participants that (a) have been exposed to a stimulus and (b) have not been exposed to the stimulus.
